(19) United States
(12) Patent Application Publication
(10) Pub. No.: US 2009/0110132 A1
(43) Pub. Date: Apr. 30, 2009

(54) SYSTEM AND METHOD FOR RE-SYNCHRONIZATION OF A PSS SESSION TO AN MBMS SESSION

(75) Inventors: Lukasz Kondrad, Tampere (FI); Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/255,585

(22) Filed: Oct. 21, 2008

Related U.S. Application Data
(60) Provisional application No. 60/982,718, filed on Oct. 25, 2007.

(51) Int. Cl. H04L 7/00

(52) U.S. Cl. 375/354

(57) ABSTRACT

An accurate indication of a re-synchronization point/time in streamed media content is provided to allow playout of the streamed media content from or at a desired point/time when a client or receiver switches from multimedia broadcast multicast service (MBMS) to packet switch stream (PSS) service. Various parameters, e.g., synchronization source (SSRC) and real-time protocol (RTP) timestamp, of a last received media RTP packet is signaled to a receiver. Alternatively, the SSRC and sequence number of the last received media RTP packet is signaled to the receiver, or the SSRC, the RTP timestamp, and the sequence number of the last received media RTP packet is signaled to the receiver. Also, a UTC clock time can be calculated based upon the last received real-time control protocol (RTCP) sender report (SR) and the timestamp of the last received media RTP packet in order to effectuate proper synchronization between MBMS and PSS servers.

### CROSS-REFERENCE TO RELATED PATENT APPLICATIONS

This application claims priority from Provisional Application U.S. Application 60/982,718, filed Oct. 25, 2007, incorporated herein by reference in its entirety.

### FIELD OF THE INVENTION

The present invention relates generally to the use of multiple technologies for accessing streamed content. More particularly, the present invention relates to the synchronization/re-synchronization of two sources when the type of access to streamed content changes.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Streaming media can be described as multimedia content that is continuously received and displayed to an end-user while it is being delivered by a provider. Hence, the term “streaming media” more correctly describes and refers to a delivery method of the medium rather than to the medium itself. Streaming media can be handled/processed in different ways including, but not limited to, technologies referred to as unicast, multicast, and broadcast techniques.

Unicast usually refers to a technique of sending information packets to a single destination, e.g., a “one-to-one” technique. Unicast is conventionally handled by a real-time streaming protocol (RTSP). In RTSP, a connection between a server and a client is usually established before transmission.

Multicast and broadcast techniques conventionally refer to two types of a “one-to-many” technique, e.g., a server may transmit to multiple clients. One difference between broadcasting and multicasting relates to receiving devices. In broadcasting, a packet sent by a source/server is usually received by every device on a network. In multicasting, only devices/receivers that are subscribed to a multicasting group may usually receive the transmitted content. Both of these one-to-many techniques may be scaled to accommodate a larger population of receivers by not requiring prior knowledge of the number of receivers that exist in the network and/or are subscribed to receive transmitted content. It should be noted that the multicasting utilizes network infrastructure more efficiently by requiring the source to send a packet only once, even if the packet needs to be delivered to a large number of receivers. Nodes in the applicable network take care of replicating the packet to reach multiple receivers only where/when necessary. However, when using multicasting and broadcasting, a client usually does not have any connection with the server.

Three protocols, e.g., RTSP, real-time transport protocol (RTP), and real-time transport control protocol (RTCP), have been designed to handle the receipt, transmission, control, etc. of streamed media. RTP and RTCP are usually built on top of the user datagram protocol (UDP).

RTSP is conventionally utilized to establish and control time-synchronized streams of continuous media. The protocol itself is textual and “stateful”. In other words, with RTSP, a session ID, for example, is used to keep track of session when needed so that no permanent transmission control protocol (TCP) is needed. Furthermore, in RTSP, media data is delivered out-of-band using a separate transport protocol, e.g., RTP.

Streaming technology has multiple commercial applications including but not limited to, 3^{rd} Generation Partnership Project (3GPP) Packet Switch Streaming (PSS) services, 3GPP multimedia broadcast multicast service (MBMS), IP Datacast over Digital Video Broadcasting Handheld (DVB-H), and is also widely used over the public Internet. 3GPP PSS defines a framework for an interoperable streaming service in 3GPP mobile networks, where the service uses a unicast mode to access streamed media. 3GPP MBMS is a solution that may also be offered in 3GPP mobile networks. Using MBMS, video and audio clips may be transferred and real streaming is also possible via such a system. As an alternative to MBMS, DVB-H technology may also be utilized.

### SUMMARY OF THE INVENTION

Various systems and methods are provided for accurately indicating a re-synchronization point/time in streamed media content to allow for playout of the streamed media content from or at a desired point/time when, for example, a client or receiver switches from MBMS to PSS service. In accordance with one exemplary embodiment, a method of re-synchronizing a packet-switch streaming service (PSS) session to a multimedia broadcast multicast service (MBMS) streaming session is described. The method may comprise receiving a media stream comprising a plurality of media packets, and indicating a re-synchronization point within the media stream associated with a desired playout. The method may further comprise a process for determining an indication of the re-synchronization point by receiving a synchronization parameter value and at least one of a timestamp value and a sequence number value of a last received media packet of the plurality of media packets. Alternatively, the method may further comprise another process for determining the indication of the re-synchronization point by calculating a clock time value based on a last received sender report and a timestamp value of the last received media packet of the plurality of media packets.

According to various embodiments, the synchronization/re-synchronization that occurs when a client moves from a MBMS service to a PSS service need not depend on the client itself, but rather may depend on service provider servers, where either the MBMS and PSS servers stream the same RTP stream, or the MBMS server informs the PSS server when the transmission of the content starts.

These and other features of the various embodiments described herein, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flow chart showing signaling between a client and a server in an RTSP session setup process;

FIG. 2 is a representation of an RTP header structure;

FIG. 3 is an overview diagram of a system in which exemplary embodiments of the present invention may be implemented in accordance with one exemplary use case;

FIG. 4 is an overview diagram of a system in which exemplary embodiments, of the present invention, may be implemented in accordance with another exemplary use case;

FIG. 5 is a diagram representative of RTP and RTCP streams flowing between a client and a server in accordance with yet another exemplary embodiment of the present invention;

FIG. 6 is a perspective view of an electronic device that can be used in conjunction with the implementation of various embodiments; and

FIG. 7 is a schematic representation of the circuitry which may be included in the electronic device of FIG. 6.

### DETAILED DESCRIPTION OF THE PREFERRED EMBODIMENTS

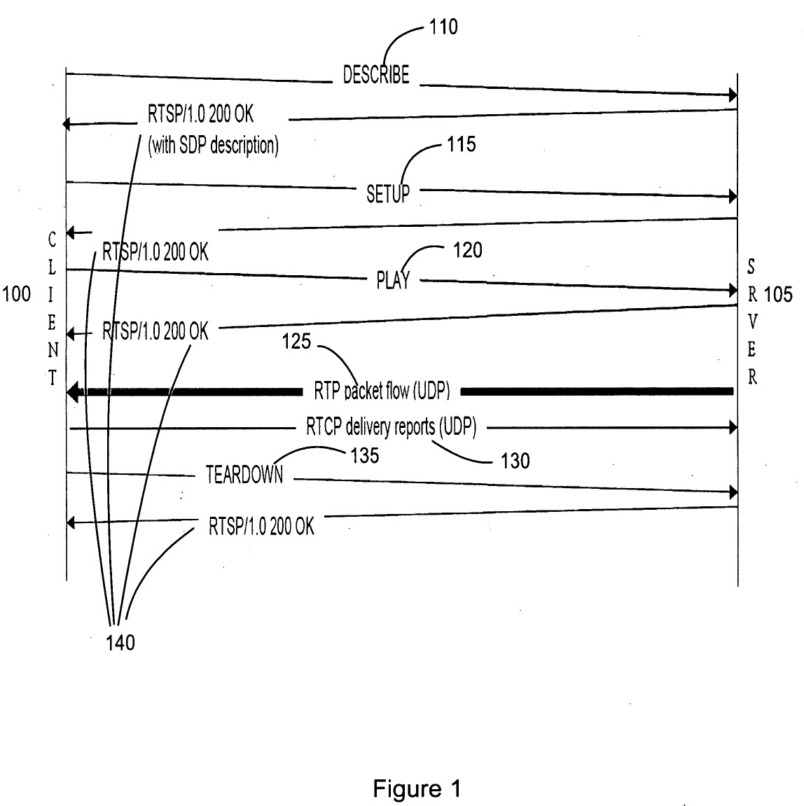

FIG. 1 is a flow chart showing signaling between a client and a server in an RTSP session setup process. First, a client 100 learns of the location of a media clip, for example, by browsing to a web page that has an RTSP universal resource locator (URL). Next, the client 100, e.g., a streaming media player, connects to a streaming server 105 that is hosting the web page and/or streaming media and issues a RTSP DESCRIBE command 110. The server responds with a session description protocol (SDP) description. The SDP description may include information regarding, for example, the number of streams, media types, and required bandwidth. It should be noted that the SDP description is usually sent within an acknowledgement, e.g., an RTSP/1.0 200 OK message 140. After parsing the SDP description, the client 100 can issue an RTSP SETUP command 115 for each stream in the session. The SETUP command 115 may indicate to the server 105 which ports the client 100 uses to receive the media. The client 100 may also indicate which part of the stream is desired for display. The client 100 issues a PLAY command 120, for example, once media streams have been set up. The server 105 may then start sending the media streams as RTP packets 125 over UDP to the client. The server 105 may also receive RTCP delivery reports 130 over UDP. RTCP delivery reports 130 comprise, e.g., feedback regarding the quality of service being provided in relation to the media stream. In order to end the media streaming session, the client 100 may issue a TEARDOWN command 135.

In an RTSP session, the client 100 may indicate a time instant of a streamed media content specifying a desired starting point for media content consumption. For example, a client may wish to start, or continue, viewing a streamed video, e.g., a movie, at a specific scene or frame of the video sequence. To accomplish this feature, the RTSP protocol provides request and response header fields which may specify a range of time, usually described in numbers of units. For example, the Society of Motion Picture and Television Engineers (SMPTE) relative timestamp, the normal play time (NPT) defined in multimedia broadcast multicast service (MBMS), and the Coordinated Universal Time (UTC) range units may be defined for this purpose. Alternatively, RTSP allows for the possibility of creating new options by using an optional tag.

For example, a SMPTE relative timestamp expresses time relative to the start of a clip of media content, e.g., a movie clip. Relative timestamps are expressed as SMPTE time codes for frame-level access accuracy, where a time code has a format of hours:minutes:seconds:frames.subframes with the origin of the time code being at the start of, e.g., the movie clip.

NPT alternatively indicates the media stream's absolute position relative to the beginning of its presentation. Therefore, the timestamp comprises a decimal fraction, where the portion left of the decimal point may be expressed in either seconds or in hours, minutes and seconds. The portion to the right of the decimal point measures fractions of a second. The beginning of a presentation corresponds to 0.0 seconds.

With regard to UTC, absolute time may be expressed as ISO 8601 timestamps, using UTC Greenwich Mean Time (GMT). Fractions of a second may be indicated as well using UTC.

Optional tags may be unique identifiers used to designate new options in RTSP as described above. Optional tags may be used in Require, Supported, and Proxy-Require header fields.

RTP, as opposed to RTSP, is a standardized packet format for delivering, e.g., audio and video over the Internet. RTP is a transport protocol that provides end-to-end network transport functions suitable for applications transmitting real-time data. Real-time data includes audio and/or video over multicast technologies (e.g., Digital Video Broadcasting Handheld (DVB-H) or 3^{rd} Generation Partnership Project (3GPP) MBMS) or over unicast technologies (e.g., 3GPP Packet-Switch Streaming Service (PSS) network services). RTP provides a technique for sending real-time or streaming data over UDP.

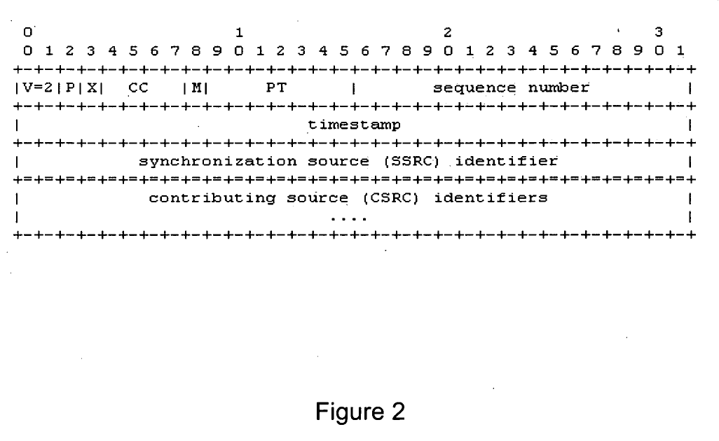

FIG. 2 is a representation of an RTP header structure. A RTP packet usually contains an RTP header which may consist of at least 12 bytes. The first two bits indicate the protocol version which, in the example represented in FIG. 2, is 2. The P bit is indicative of whether or not there are extra padding bytes at the end of the RTP packet. The X bit may indicate whether or not extensions to the protocol are being used in the packet. Four CC bits usually contain the number of contributing source (CRSC) identifiers that follow the fixed header. The M bit may be used at the application level and is defined by some profile, where if the M bit is set, it indicates that the current data has some special relevance for the application. The seven PT bits indicate the format of the payload and determines its interpretation by the application.

Further in relation to the RTP packet of FIG. 2, a packet sequence number is usually incremented by one for each RTP data packet sent and may be used by a receiver to detect packet loss and to restore packet sequence. The initial value of the packet sequence number is random and therefore, unpredictable. The timestamp reflects a sampling instant of the first octet in the RTP data packet. The sampling instant is derived from a clock that increments monotonically and linearly in time to allow for synchronization and jitter calculations. A synchronization source (SSRC) identifier, with a corresponding field, identifies a synchronization source. The SSRC identifier is usually chosen randomly with the intent that no two synchronization sources within the same RTP session will have the same SSRC identifier.

RTCP is based on a periodic transmission of control packets to all participants in a session. The periodic transmission of control packets may use the same distribution mechanism as the data packets. The underlying protocol may provide multiplexing of the data and control packets, for example, by using separate port numbers with UDP. RTCP may, usually, perform different functions, among which providing feedback on the quality of the data distribution as described above. RTCP may also carry a persistent transport-level identifier for an RTP source referred to as the “canonical name”. Inter-media synchronization usually requires that the NTP and RTP timestamps be included in RTCP packets by data senders. Usually, all participants may be required to send RTCP packets. In order for RTP to scale up to a large number of participants, the rate of transmission may be controlled. By having each participant send its control packets to all other participants, each participant may independently observe/determine the number of participants that exist. This number may then be used to calculate the rate at which the RTCP packets are sent. Another function, which is usually optional, of RTCP is to convey minimal session control information, e.g., a participant's identification that is to be displayed in a user interface. Such a function may be useful, at least in, in “loosely controlled” sessions where participants enter and leave without membership control or parameter negotiation.

Currently, when a user wishes to switch from MBMS to PSS service, e.g., if a terminal detects that it has come out of an MBMS coverage area, the service is re-synchronized based on UTC clock time or NPT. NPT is used when the PSS client and/or server do not support accurate re-synchronization or time shifting. Hence, playout can then only start from the current instant based on the data that is currently available at the PSS server. In this case, the NPT time with a range indication of “now” is used.

If a PSS server supports time shifting, a user may request a specific start time of the PSS session by indicating a UTC clock time in a “Range” header field of a PLAY request. However, it is not specified how the UTC clock time is calculated. The UTC clock time of the server and the client are not synchronized which may result in the client receiving a media range different from what is originally requested.

Various exemplary embodiments, of the present invention, provide devices, systems and methods for accurately indicating a re-synchronization point/time in a streamed media content in order to allow for playout of the streamed media content from or at a desired point/time when, for example, a client or receiver switches from MBMS to PSS service. Such exemplary embodiments described herein may be implemented by appropriately setting up MBMS and PSS servers. It should be noted that various embodiments described herein can be implemented in and with different broadcast/multicast and unicast streaming services. Descriptions recited herein directed to MBMS and PSS service and servers are for exemplary purposes only and should not be interpreted in a restricting sense. In accordance with one exemplary embodiment, the SSRC and RTP timestamp of a last received media RTP packet are signaled to the receiver. According to another exemplary embodiment, the SSRC and sequence number of the last received media RTP packet are signaled to the receiver. In accordance with yet another exemplary embodiment, the SSRC, the RTP timestamp, and the sequence number of the last received media RTP packet are signaled to the receiver. According to another exemplary embodiment a UTC clock time is calculated based upon the last received RTCP sender report (SR) and the timestamp of the last received media RTP packet.

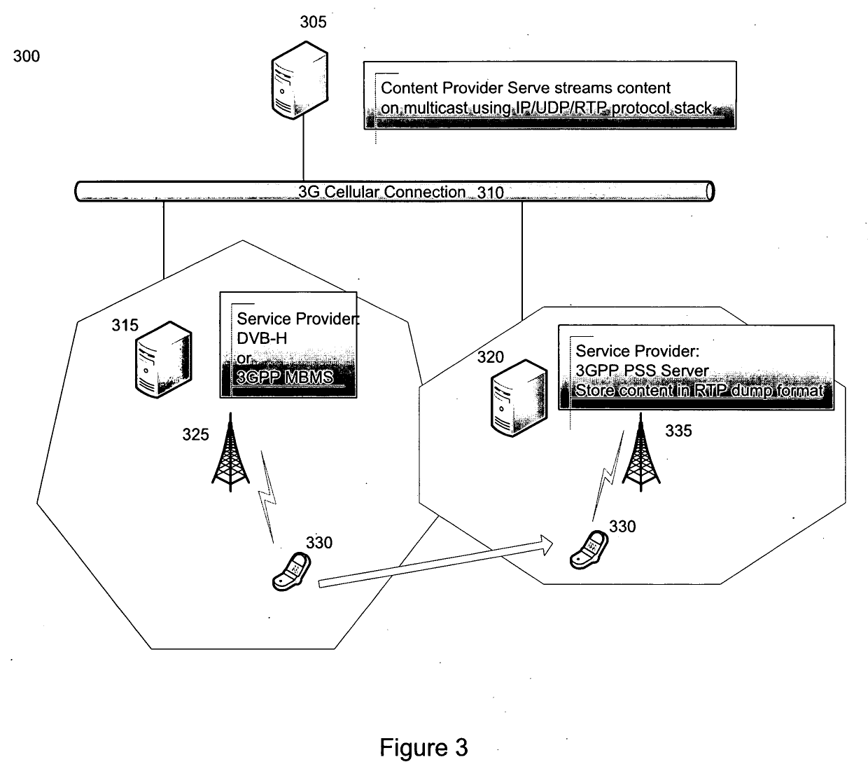

FIG. 3 is an overview diagram of a system 300 in which exemplary embodiments of the present invention may be implemented in accordance with one exemplary use case. A content provider server 305 is communicatively connected, for example, to a MBMS server 315 and a PSS server 320 through, e.g., a Third Generation (3G) cellular connection. Other types of connections may also be contemplated. The MBMS server 315 and the PSS server 320 may receive media streams from the content provider server 305, for example, by joining a multicast group to which the content provider server 305 transmits the streamed media content. According to one exemplary embodiment, the PSS server 320 stores incoming streams in some type of appropriate format, e.g., RTPdump format. The RTPdump format may allow seeking media content based on SSRC, timestamp, and/or sequence number of a packet corresponding to the media content. thereby allowing for the implementation of various embodiments described above. Other types of formats may also be utilized in various embodiments to store incoming media streams. The PSS server 320 may share the same media content provided by the MBMS server 315. However, the media content, shared by the PSS server 320 and the MBMS server 315, may have a representation at the PSS server 320 that is different from the media content representation at the MBMS server 315. For example, the PSS server 320 may transcode the media content while keeping, for example, a hint track that may match the original RTP timestamp(s) and/or sequence number(s) to the timestamp(s) and/or sequence number(s) of new media units in the transcoded media content. As also described above, e.g., in paragraph [0031], various embodiments may be implemented for situations when a client/receiver, e.g., mobile telephone 330 moves from an area providing MBMS service to an area where no MBMS service is available, and/or when a requested service is not available.

It should be noted that the system 300 may comprise multiple communication devices that may communicate through a network, and may also comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. For exemplification, the system 300 shown in FIG. 3 may include service providers which allow for communication between devices as well as the transmission and reception of streamed media content through, for example, a wireless connection to base stations 325 and 335.

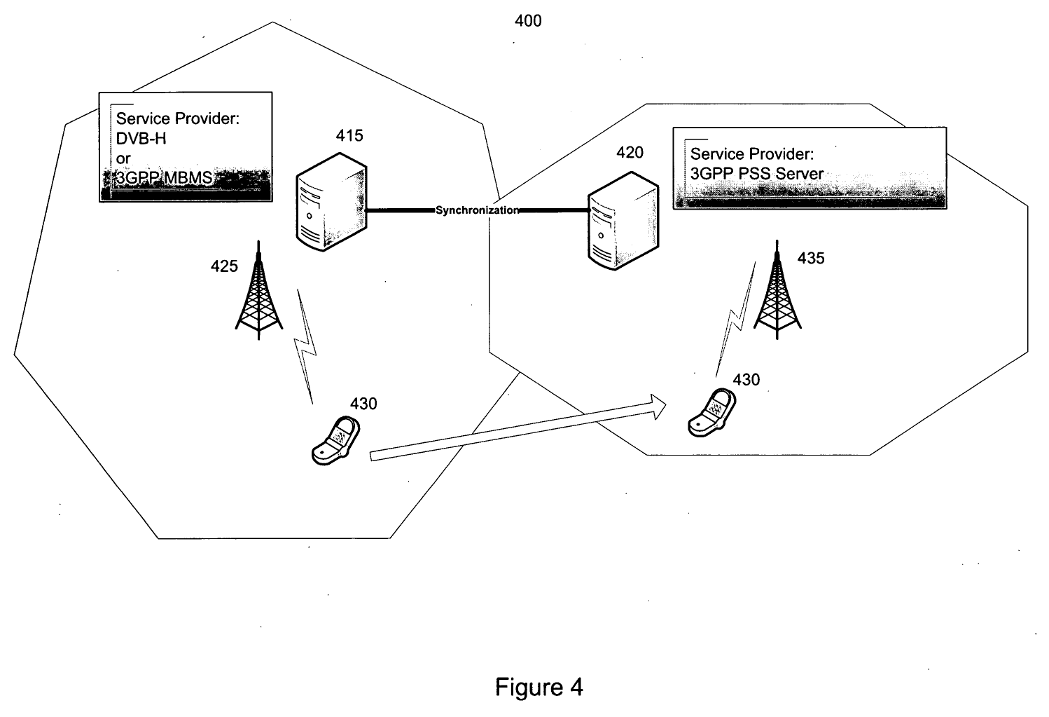

FIG. 4 is an overview diagram of a system in which exemplary embodiments, of the present invention, may be implemented in accordance with another exemplary use case. In FIG. 4, The MBMS server 415 and the PSS server 420, which may provide unicast access to the MBMS service, are time synchronized. The PSS server 420 may also support time shifting. According to one exemplary embodiment, the PSS server 420 and the MBMS server 415 store the same content and the MBMS server 415 is able to inform the PSS server 420 as to when the streaming session with the media content began. Alternatively, the PSS server 420 and the MBMS server 415 may not need to have the same content stored. That is, according to another exemplary embodiment, the PSS server 420 may act as a receiver to the MBMS server 415. According to yet another exemplary embodiment, the PSS server 420 and the MBMS server 415 may both act as receivers of the same content (as for example, described in relation to FIG. 3) from a third entity. The PSS server 420 may also transcode media content to a representation that is more suitable for a unicast mode of delivery. Transcoding, usually, preserves the original timeline associated with the media content, e.g. before transcoding. In order to effectuate proper re-synchronization, the UTC clock time is calculated based on the last received RTCP SR and timestamp of the last received media RTP packet in accordance with one embodiment described, e.g., in paragraph [0031], above, and as described in paragraphs [0039]-[0044] below.

The system 400 of FIG. 4 may comprise multiple communication devices that may communicate through a network, and may also comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. For exemplification, the system 400 may include service providers which allow for communication between devices as well as the transmission and reception of streamed media content through, for example, a wireless connection to base stations 425 and 445. The service providers may provide services that allow the movement of a mobile telephone 430 from a MBMS server to a PSS service.

According to one exemplary embodiment, SSRC and RTP timestamp may be signaled for accurately indicating a re-synchronization point/time. According to such an embodiment, if deciding to change from an MBMS service to a PSS service, a client/receiver extracts the timestamp and SSRC values from the last received RTP media packet, which was received from an MBMS server. The SSRC value describes the media, where each piece, set, or group of media has a different SSRC value. The timestamp value indicates the position/time in the RTPdump file, for example, from which the PSS server is to start presenting the streamed media. It should be noted that the current RTSP specification allows for the use of optional tags. The optional tags may be used to send a new range request to the PSS server. The PSS server may support the optional tag value. Based on the received SSRC and timestamp values, The PSS server is able to seek through the stored, e.g., RTPdump file(s) for the appropriate starting point at which to commence presentation of the streamed media.

In accordance with another exemplary embodiment, a processes may be performed, where instead of the RTP timestamp being extracted from the last received RTP media packet as in the previous embodiment, the sequence number value is extracted from the RTP header of the last received RTP media packet. The sequence number value is then used for synchronization/re-synchronization purposes. Furthermore, in accordance with yet another exemplary embodiment, both the RTP timestamp and the sequence number values of the last received RTP media packet may be signaled. In such a scenario, a process where both the RTP timestamp and the sequence number values are used as a synchronization/re-synchronization point, may be performed. Using both the RTP timestamp and the sequence number values may provide for greater ranges of time shifting.

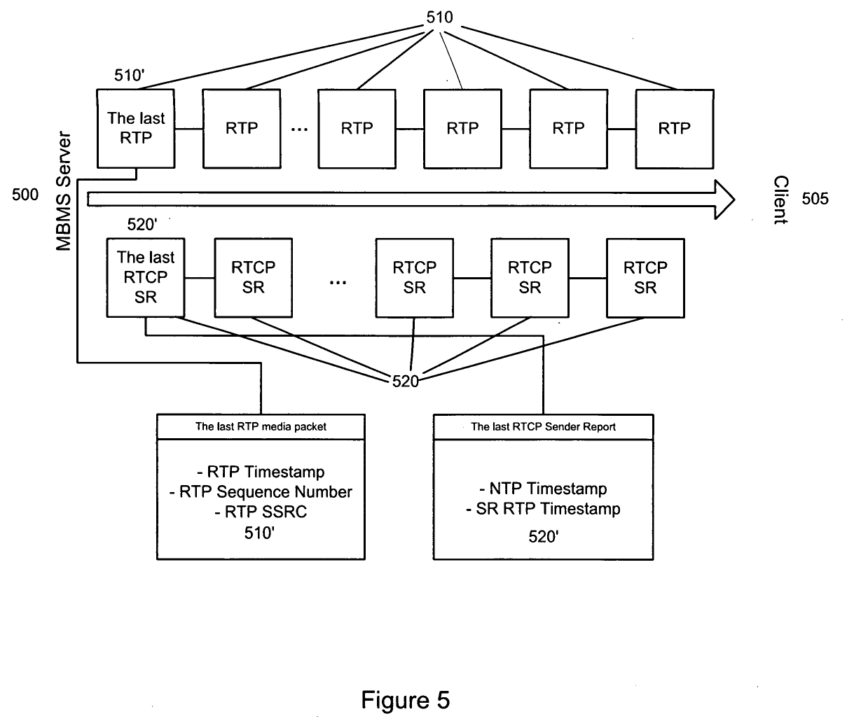

FIG. 5 is a diagram representative of RTP and RTCP streams flowing between a client and a server in accordance with yet another exemplary embodiment of the present invention. According to this embodiment, a UTC clock time is calculated based upon the last received RTCP sender report (SR) and the timestamp of the last received media RTP packet. Such an embodiment may be used, for example, when a user receives service through MBMS and the service consisting of at least two media streams, e.g. audio and video. Audio and video may be streamed over two separate ports of a MBMS server 500 to a client 505 using RTP as the transport protocol, e.g., RTP media packets 510. For each of the media RTP streams, the MBMS server 500, usually, sends RTCP streams for audio and video comprising RTCP SRs 520.

Each RTCP SR, usually, contains a 64-bit network time protocol (NTP) timestamp field which indicates a “wallclock” time and a 32-bit RTP timestamp field which corresponds to the same time as the NTP timestamp. However, the 32-bit RTP timestamp field is expressed in the same units and with the same random offset as the RTP timestamps contained in data packets. Based on this correspondence along with the timestamp value of the last received RTP media packet 510′ (with a corresponding last received RTCP SR 520′), the NTP timestamp for the last received RTP media packet 510′ is then calculated. Thereafter, the NTP timestamp value for the last received RTP media packet 510′ is converted to an appropriate UTC clock time. The UTC clock time value is then utilized to synchronize the MBMS server 500 and the client 505 to allow the client 505 to receive a streamed media range commensurate with the range it originally requested. In other words, the client 505/receiver extracts the point/time at which a multicast/broadcast transmission from the MBMS server 500 has stopped. That point/time is usually relative to the MBMS server 500 timeline. The extracted point/time is then converted and sent to, e.g., a PSS server which may map that point/time to its own timeline to determine a corresponding RTP packet at which to start playout with. At the server side, a reverse process may be applied where the timestamp of the first RTP media packet associated with a playout starting point/time requested by a receiver is recovered. That is, at the MBMS server 500, the UTC clock time value may be converted back to an NTP timestamp value, where the NTP timestamp value is utilized to determine the RTP timestamp commensurate with the first RTP media packet associated with the requested playout starting point/time.

The time shift between the last received RTP media packet and the last received RTCP SR is expressed in terms of Equations (1) and (2) below. Equations (3) and (4), below, may then be used to determine the NTP timestamp of the last received RTP media packet:

$$\begin{matrix}{Δ}^{A} = \frac{R T {P}_{TSSR}^{A} - R T {P}_{TSL}^{A}}{C {R}^{A}} & ( 1 ) \\ {Δ}^{V} = \frac{R T {P}_{TSSR}^{V} - R T {P}_{TSL}^{V}}{C {R}^{V}} & ( 2 )\end{matrix}$$

NTP_{TSL}^{A}=NTP_{TSSR}^{A}+Δ^{A} (3)

NTP_{TSL}^{V}=NTP_{TSSR}^{V}+Δ^{V} (4)

where,
NTP_{TSREQ}—NTP timestamp requested by the User Equipment (UE)/client
NTP_{TSSR}^{A}—NTP timestamp from the fast received Sender Report (Audio)
NTP_{TSSR}^{V}—NTP timestamp from the fast received Sender Report (Video)
RTP_{TSSR}^{A}—RTP timestamp from the fast received Sender Report (Audio)
RTP_{TSSR}^{V}—RTP timestamp from the fast received Sender Report (Video)
NTP_{TSL}^{A}—NTP timestamp for the fast received RTP media packet (Audio)
NTP_{TSL}^{A}—NTP timestamp for the fast received RTP media packet (Video)
RTP_{TSL}^{A}—RTP timestamp from the fast received RTP media packet (Audio)
RTP_{TSL}^{V}—RTP timestamp from the fast received RTP media packet (Video)

### CR^{A}—Clock Rate for Audio

### CR^{V}—Clock Rate for Video

Δ^{A}—shift between the fast received SR NTP TS and the fast received RTP media packet NTP TS (Audio)
Δ^{V}—shift between the fast received SR NTP TS and the fast received RTP media packet NTP TS (Video)

Because there might be a difference between the last received audio and video packets the minimum value from the audio and video NTP timestamp values may be chosen as the synchronization value as shown in Equation (5). A loss of media data from one media stream is then avoided, although data from the other media stream(s) may be received redundantly.

NTP_{TSREQ}=min(NTP_{TSL}^{A},NTP_{TSL}^{V}) (5)

Subsequently, the chosen NTP value is converted to a UTC wallclock time, as described above, and the client/UE may request a specific start time of the PSS session by indicating a UTC clock time in the “Range” header field of the PLAY request. However, how the PSS server reacts in response to the request depends upon the scenario at issue, e.g., the first use case or the second use case, both of which are described above in relation to FIGS. 3 and 4.

In accordance with the first use case, the PSS server 320 converts the UTC clock time back to a NTP timestamp and based on that NTP timestamp, determines the RTP timestamps of the audio and video streams which indicate the starting point of the PSS session. In other words, the sender report NTP timestamp shown in Equations (6) and (7) and the sender report RTP timestamp shown in Equations (8) and (9) are extracted from the sender report sent by the content provider server 305.

Δ^{A}=NTP_{TSSR}^{A}−NTP_{TSREQ} (6)

Δ^{V}=NTP_{TSSR}^{V}−NTP_{TSREQ} (7)

RTP_{TSREQ}^{A}=RTP_{TSSR}^{A}−(Δ^{A}·CR^{A}) (8)

RTP_{TSREQ}^{V}=RTP_{TSSR}^{V}−(Δ^{V}·CR^{V}) (9)

In accordance with the second use case, the PSS server 420 may determine the NPT which is indicative of the appropriate playout starting point. This is accomplished based on the received UTC clock time and the relevant timing information (e.g., RTP timestamp) from the MBMS server 415 when the media content began playing which is in the UTC clock time format.

Various embodiments described herein provide devices, systems and methods for accurately indicating a position/time of the received media content. Synchronization/re-synchronization need not depend on any client/UE, but rather may depend on service provider servers, where either the MBMS and PSS servers stream the same RTP stream, or the MBMS server informs the PSS server when the transmission of the content starts.

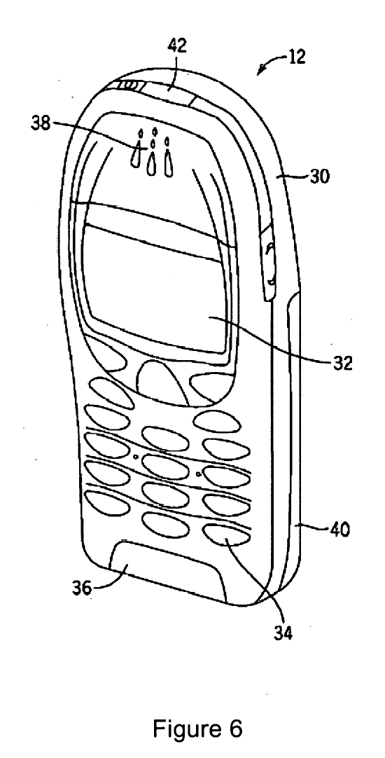

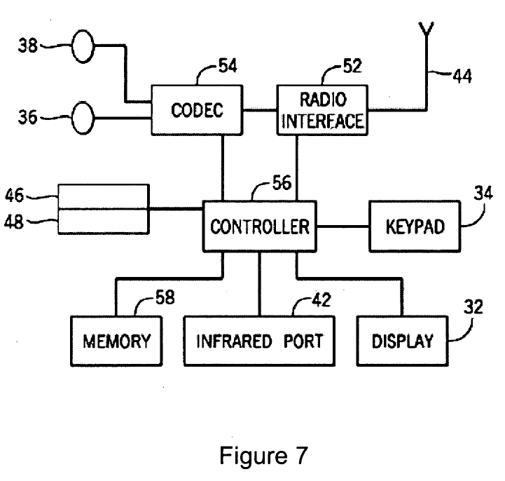

FIGS. 6 and 7 show one representative electronic device 12, e.g., a mobile telephone such as that described in relation to FIGS. 3 and 4, within which various embodiments of the present invention may be implemented. Each of the various devices described in the present application may contain one or more of the elements depicted in the electronic device 12 of FIGS. 6 and 7. It should be understood, however, that the present invention is not intended to be limited to one particular type of electronic device 12. The electronic device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80.

Various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Furthermore, the various embodiments of the present invention can be implemented within various networks, network elements, and servers of various service providers.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, particular standards, releases, and/or versions thereof, are described or otherwise mentioned herein, such references are not intended and should not be interpreted as limiting the scope of the following claims.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

Embodiments of the present invention may be implemented in software, hardware, application logic or a combination of software, hardware and application logic. The software, application logic and/or hardware may reside on a chipset, a mobile device, a desktop, a laptop or a server. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

The foregoing description of embodiments have been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of re-synchronizing a packet-switch streaming service (PSS) session to a multimedia broadcast multicast service (MBMS) streaming session, comprising:
transmitting a media stream comprising a plurality of media packets from which a re-synchronization point is indicated within the media stream associated with a desired playout, wherein an indication of the re-synchronization point is determined by at least one of:
signaling a synchronization parameter value and at least one of a timestamp value and a sequence number value of a last received media packet of the plurality of media packets; and
calculating a clock time value based on a last received sender report and a timestamp value of the last received media packet of the plurality of media packets.

2. The method of claim 1, wherein the indication of the re-synchronization point is determined upon a client moving from the MBMS streaming session to the PSS session.

3. The method of claim 1, wherein the synchronization parameter value is indicative of a synchronization source, the timestamp value comprises a real-time protocol (RTP) timestamp value, and the sequence number is utilized for packet loss detection and packet sequence restoration.

4. The method of claim 1, wherein prior to the signaling, a PSS server and a MBMS server join a multicast group for receiving the media stream simultaneously from a content provider server.

5. The method of claim 4, wherein the PSS server stores the media stream in a RTPdump format.

6. The method of claim 5, wherein the indicating of the re-synchronization point further comprises extracting the synchronization parameter value and the at least one of the timestamp value and the sequence number value from the last received media packet.

7. The method of claim 6 further comprising, seeking content within the media stream associated with the re-synchronization point based on the synchronization parameter value and the at least one of the timestamp value and the sequence number value.

8. The method of claim 4, wherein the PSS server supports use of an optional tag value to send a range request to the MBMS server.

9. The method of claim 1, wherein prior to the calculating, a client receives the MBMS streaming session via a MBMS server.

10. The method of claim 9, wherein the MBMS server transmits a plurality of send reports to the client, a last send report of the plurality of send reports associated with the last received media packet comprising at least a network time protocol (NTP) timestamp value, and wherein the timestamp value of the last received media packet is calculated and the NTP timestamp value is converted to a coordinated universal time (UTC) clock time for synchronization with the MBMS server.

11. A computer program product, embodied on a computer-readable medium, comprising computer code configured to perform the processes of claim 1.

12. An apparatus, comprising:
a processor; and
a memory unit communicatively connected to the processor and including:
computer code configured to transmit a media stream comprising a plurality of media packets from which a re-synchronization point is indicated within the media stream associated with a desired playout to re-synchronize a packet-switch streaming service (PSS) session to a multimedia broadcast multicast service (MBMS) streaming session, wherein an indication of the re-synchronization point is determined by at least one of:
signaling a synchronization parameter value and at least one of a timestamp value and a sequence number value of a last received media packet of the plurality of media packets; and
calculating a clock time value based on a last received sender report and a timestamp value of the last received media packet of the plurality of media packets.

13. The apparatus of claim 12, wherein the indication of the re-synchronization point is determined upon a client moving from the MBMS streaming session to the PSS session.

14. The apparatus of claim 12, wherein the synchronization parameter value is indicative of a synchronization source, the timestamp value comprises a real-time protocol (RTP) timestamp value, and the sequence number is utilized for packet loss detection and packet sequence restoration.

15. The apparatus of claim 12, wherein prior to the signaling, a PSS server and the apparatus join a multicast group for receiving the media stream simultaneously from a content provider server.

16. The apparatus of claim 15, wherein the PSS server stores the media stream in a RTPdump format.

17. The apparatus of claim 16, wherein the PSS server further comprises computer code configured to extract the synchronization parameter value and the at least one of the timestamp value and the sequence number value from the last received media packet.

18. The apparatus of claim 17, where the PSS server further comprises computer code configured to seek content within the media stream associated with the re-synchronization point based on the synchronization parameter value and the at least one of the timestamp value and the sequence number value.

19. The apparatus of claim 15, wherein the PSS server supports use of an optional tag value to send a range request to the MBMS server.

20. The apparatus of claim 12, wherein prior to the calculating, the apparatus transmits the MBMS streaming session to a client.

21. The apparatus of claim 20, wherein the memory unit further comprises computer code configured to transmit a plurality of send reports to the client, a last send report of the plurality of send reports associated with the last received media packet comprising at least a network time protocol (NTP) timestamp value, and wherein the timestamp value of the last received media packet is calculated and the NTP timestamp value is converted to a coordinated universal time (UTC) clock time for synchronization with the apparatus.

22. A server, comprising:
means for transmitting a media stream comprising a plurality of media packets from which a re-synchronization point is indicated within the media stream associated with a desired playout to re-synchronize a packet-switch streaming service (PSS) session to a multimedia broadcast multicast service (MBMS) streaming session, wherein an indication of the re-synchronization point is determined by at least one of:
signaling a synchronization parameter value and at least one of a timestamp value and a sequence number value of a last received media packet of the plurality of media packets; and
calculating a clock time value based on a last received sender report and a timestamp value of the last received media packet of the plurality of media packets.

23. The server of claim 22, wherein the indication of the re-synchronization point is determined upon a client moving from the MBMS streaming session to the PSS session.

24. A method of re-synchronizing a packet-switch streaming service (PSS) session to a multimedia broadcast multicast service (MBMS) streaming session, comprising:
receiving a media stream comprising a plurality of media packets; and
indicating a re-synchronization point within the media stream associated with a desired playout, wherein an indication of the re-synchronization point is determined by at least one of:
receiving a synchronization parameter value and at least one of a timestamp value and a sequence number value of a last received media packet of the plurality of media packets; and
calculating a clock time value based on a last received sender report and a timestamp value of the last received media packet of the plurality of media packets.

25. The method of claim 24, wherein the indicating of the re-synchronization point occurs upon a client moving from the MBMS streaming session to the PSS session.

26. The method of claim 24, wherein the synchronization parameter value is indicative of a synchronization source, the timestamp value comprises a real-time protocol (RTP) timestamp value, and the sequence number is utilized for packet loss detection and packet sequence restoration.

27. The method of claim 24, wherein prior to the signaling, a PSS server and a MBMS server join a multicast group for receiving the media stream simultaneously from a content provider server.

28. The method of claim 27, wherein the PSS server stores the media stream in a RTPdump format.

29. The method of claim 28, wherein the indicating of the re-synchronization point further comprises extracting the synchronization parameter value and the at least one of the timestamp value and the sequence number value from the last received media packet.

30. The method of claim 29 further comprising, seeking content within the media stream associated with the re-synchronization point based on the synchronization parameter value and the at least one of the timestamp value and the sequence number value.

31. The method of claim 27, wherein the PSS server supports use of an optional tag value to send a range request to the MBMS server.

32. The method of claim 24, wherein prior to the calculating, a client receives the MBMS streaming session via a MBMS server.

33. The method of claim 9, wherein the MBMS server transmits a plurality of send reports to the client, a last send report of the plurality of send reports associated with the last received media packet comprising at least a network time protocol (NTP) timestamp value, and wherein the timestamp value of the last received media packet is calculated and the NTP timestamp value is converted to a coordinated universal time (UTC) clock time for synchronization with the MBMS server.

34. A computer program product, embodied on a computer-readable medium, comprising computer code configured to perform the processes of claim 24.

35. An apparatus, comprising:
a processor; and
a memory unit communicatively connected to the processor and including:
computer code configured to receive a media stream comprising a plurality of media packets; and
computer code configured to indicate a re-synchronization point within the media stream associated with a desired playout to re-synchronize a packet-switch streaming service (PSS) session to a multimedia broadcast multicast service (MBMS) streaming session, wherein the memory unit further comprises computer code configured to determine an indication of the re-synchronization point by at least one of:
receiving a synchronization parameter value and at least one of a timestamp value and a sequence number value of a last received media packet of the plurality of media packets; and
calculating a clock time value based on a last received sender report and a timestamp value of the last received media packet of the plurality of media packets.

36. The apparatus of claim 35, wherein the indicating of the re-synchronization point occurs upon a client moving from the MBMS streaming session to the PSS session.

37. The apparatus of claim 35, wherein the synchronization parameter value is indicative of a synchronization source, the timestamp value comprises a real-time protocol (RTP) timestamp value, and the sequence number is utilized for packet loss detection and packet sequence restoration.

38. The apparatus of claim 35, wherein prior to the signaling, the apparatus and a MBMS server join a multicast group for receiving the media stream simultaneously from a content provider server.

39. The apparatus of claim 38, wherein the memory unit further comprises computer code configured to store the media stream in a RTPdump format.

40. The apparatus of claim 39, wherein the memory unit further comprises computer code configured to extract the synchronization parameter value and the at least one of the timestamp value and the sequence number value from the last received media packet.

41. The apparatus of claim 40, wherein the memory unit further comprises computer code configured to seek content within the media stream associated with the re-synchronization point based on the synchronization parameter value and the at least one of the timestamp value and the sequence number value.

42. The apparatus of claim 38, wherein the memory unit further comprises computer code configured to support use of an optional tag value to send a range request to the MBMS server.

43. The apparatus of claim 35, wherein prior to the calculating, a client receives the MBMS streaming session via a MBMS server.

44. The apparatus of claim 43, wherein the MBMS server transmits a plurality of send reports to the client, a last send report of the plurality of send reports associated with the last received media packet comprising at least a network time protocol (NTP) timestamp value, and wherein the timestamp value of the last received media packet is calculated and the NTP timestamp value is converted to a coordinated universal time (UTC) clock time for synchronization with the MBMS server.

45. A client, comprising:
means for receiving a media stream comprising a plurality of media packets; and
means for indicating a re-synchronization point within the media stream associated with a desired playout to re-synchronize a packet-switch streaming service (PSS) session to a multimedia broadcast multicast service (MBMS) streaming session, wherein an indication of the re-synchronization point is determined by at least one of:
receiving a synchronization parameter value and at least one of a timestamp value and a sequence number value of a last received media packet of the plurality of media packets; and
calculating a clock time value based on a last received sender report and a timestamp value of the last received media packet of the plurality of media packets.

46. The client of claim 45, wherein the indicating of the re-synchronization point occurs upon a client moving from the MBMS streaming session to the PSS session.
